(19) United States
(12) Patent Application Publication
(10) Pub. No.: US 2015/0115914 A1
(43) Pub. Date: Apr. 30, 2015

(54) CONTROL CIRCUIT, SWITCHING CONVERTER AND ASSOCIATED METHOD

(71) Applicant: Chengdu Monolithic Power Systems Co., Ltd., Chengdu (CN)

(72) Inventor: Junchang Chang, Chengdu (CN)

(21) Appl. No.: 14/527,685

(22) Filed: Oct. 29, 2014

(30) Foreign Application Priority Data
Oct. 29, 2013 (CN) 201310520951.7

(51) Int. Cl. H02M 3/158

(52) U.S. Cl. CPC H02M 3/158
USPC 323/271

(57) ABSTRACT

A control circuit and a control method for a switching converter. The control circuit has a clock circuit and a comparing circuit. The clock circuit is configured to generate a clock signal to make at least one switch to operate in a first state once a rising edge of the clock signal arrives. The comparing circuit is configured to compare a feedback signal with a reference signal to generate a comparing signal, and wherein the comparing signal is configured to make the at least one switch to start to operate in a second state when the feedback signal is larger than the reference signal. The control circuit makes a switching converter to operate in a high dynamic speed with a constant switching frequency.

### CROSS-REFERENCE TO RELATED APPLICATION(S)

This application claims the benefit of CN application No. 201310520951.7 filed on Oct. 29, 2013 and incorporated herein by reference.

### TECHNICAL FIELD

The present invention generally relates to electronic circuits, and more particularly but not exclusively relates to a switching converter and associated control circuit and method.

### BACKGROUND

In the current design of portable products, both high dynamic response speed and small size are desired. Accordingly, it is challenging to design a portable product with a smaller output capacitor but having a high dynamic response speed (portable products having a high dynamic response speed are desired). In prior art, many control methods are used for controlling a switching converter, such as voltage controlled method, current controlled method, hysteresis control method, Constant On or Off Time (COT) control method, etc. Each control method has distinguished characteristics.

In a switching converter with a voltage (or current) controlled method, a difference of a voltage (and/or current) feedback signal and a reference signal may be amplified to compare with a ramp signal so that a constant frequency Pulse-Width Modulation (PWM) signal may be generated, wherein the PWM signal may be configured to regulate an output voltage by controlling on and off switching of a switch (or switches) of the switching converter. In such type of switching converters, a high-performance error amplifier is indispensible to generate and amplify the difference between the voltage/current feedback signal and the reference signal. However, an error amplifier may introduce a number of zeros and poles to a voltage (and/or current) control loop, resulting in the whole switching converter instable. In order to keep the switching converter operating in a steady state, many complex loop compensation methods should be adopted in the voltage (and/or current) loop so as to counteract impacts of these poles and zeros introduced by the error amplifier, which may decrease the dynamic response speed of the switching converter.

In a switching converter with a hysteresis control method, a hysteresis comparator may be configured to compare a voltage (and/or current) feedback signal with a reference signal, and to provide a PWM signal to regulate an output current and/or voltage by controlling on and off switching of a switch (or switches) of the switching converter. Though a high dynamic response speed of the switching converter is obtained without a high-performance error amplifier in a hysteresis control method, the switching frequency f_{SW} may be varied. In a hysteresis control method, the switching frequency f_{SW} may be related to an input voltage V_{IN}, an output voltage V_{OUT}, an Equivalent Series Resistance (ESR) R_{ESR} of an output capacitor and other associated parameters, which can be expressed by:

$${f}_{SW} = \frac{{V}_{OUT} \times ( {V}_{IN} - {V}_{OUT} ) \times {R}_{ESR} \times k}{{V}_{IN} \times L \times {V}_{hys}}$$

In the above expression, k is a fixed constant, L is an inductance of an output inductor of the switching converter, and V_{hys} is a threshold value of a hysteresis comparator. Obviously, the switching frequency f_{SW} may be varied with the input voltage V_{IN}, which is undesired in a portable product design.

In a switching converter with a COT control method, a comparator and a COT control circuit may be adopted without the need of a high-performance error amplifier. The comparator may be configured to compare a voltage (and/or current) feedback signal with a reference signal. When the voltage (and/or current) feedback signal is larger than the reference signal, the COT control circuit is configured to generate a COT signal for controlling a switch (or switches) of the switching converter on (or off) with a constant time. Therefore, a high dynamic response speed of the switching converter with a COT control method can be obtained. Theoretically, a switching frequency f_{SW} of the switching converter with COT control method should be constant once the output voltage V_{OUT} is fixed. However, in practical, since nonlinearity, time delay and non-ideal voltage drop of a switch may exist in the switching converter with a COT control method, the switching frequency f_{SW} may still inconstant.

Accordingly, a control circuit and a control method for controlling a switching converter with a high dynamic speed and a constant switching frequency are desired.

### SUMMARY

In one embodiment, the present invention discloses a control circuit for a switching converter, wherein the switching converter comprises at least one switch, and wherein the switching converter is configured to receive an input voltage signal, and wherein the switching converter is configured to convert the input voltage signal to an output voltage signal by switching the at least one switch. The control circuit comprises a clock circuit and a comparing circuit. The clock circuit is configured to generate a clock signal, wherein the clock signal is configured to make the at least one switch to operate in a first state once a rising edge of the clock signal arrives. The comparing circuit has a first input terminal, a second input terminal and an output terminal, wherein the first input terminal of the comparing circuit is configured to receive a feedback signal, and wherein the feedback signal is indicative of an output signal of the switching converter; the second input terminal of the comparing circuit is configured to receive a reference signal; the comparing circuit is configured to compare the feedback signal with the reference signal to generate a comparing signal at the output terminal; and the comparing signal is configured to make the at least one switch to operate in a second state when the feedback signal is larger than the reference signal.

In one embodiment, the present invention further discloses a control method for controlling a switching converter, wherein the switching converter comprises at least one switch, and wherein the switching converter is configured to receive an input voltage signal, and wherein the switching converter is configured to convert the input voltage signal to an output voltage signal by switching the at least one switch. The control method comprises: generating a clock signal, wherein the clock signal is configured to make the at least one switch to operate in a first state once a rising edge of the clock signal arrives; comparing a feedback signal with a reference signal to generate a comparing signal CA, wherein the comparing signal is configured to make the at least one switch to start to operate in a second state when the feedback signal is larger than the reference signal.

### BRIEF DESCRIPTION OF THE DRAWINGS

Non-limiting and non-exhaustive embodiments are described with reference to the following drawings. The drawings are only for illustration purpose. Usually, the drawings only show part of the system or circuit of the embodiment, and the same reference label in different drawings have the same, similar or corresponding features or functions.

FIG. 1 illustrates a block diagram of a switching converter according to an embodiment of the present invention.

FIG. 2 schematically illustrates a switching converter according to an embodiment of the present invention.

FIG. 3 schematically illustrates a switching converter according to an embodiment of the present invention.

FIG. 4 illustrates a schematic waveform diagram of various signals generated in each switching cycle of a switching converter according to an embodiment of the present invention.

FIG. 5 illustrates a flow diagram illustrating a control method for controlling the switching converter according to an embodiment of the present invention.

### DETAILED DESCRIPTION

The embodiments of the present invention are described in next. While the invention will be described in conjunction with various embodiments, it will be understood that they are not intended to limit the invention to these embodiments. On contrary, the invention is intended to cover alternatives, modifications and equivalents, which may be included within the spirit and scope of the invention as defined by the appended claims. Furthermore, in the following detailed description of the embodiments of the present invention, numerous specific details are set forth in order to provide a thorough understanding of the embodiments of the present invention. However, it will be obvious to one of ordinary skill in the art that without these specific details the embodiments of the present invention may be practiced. In other instance, well-know circuits, materials, and methods have not been described in detail so as not to unnecessarily obscure aspect of the embodiments of the present invention.

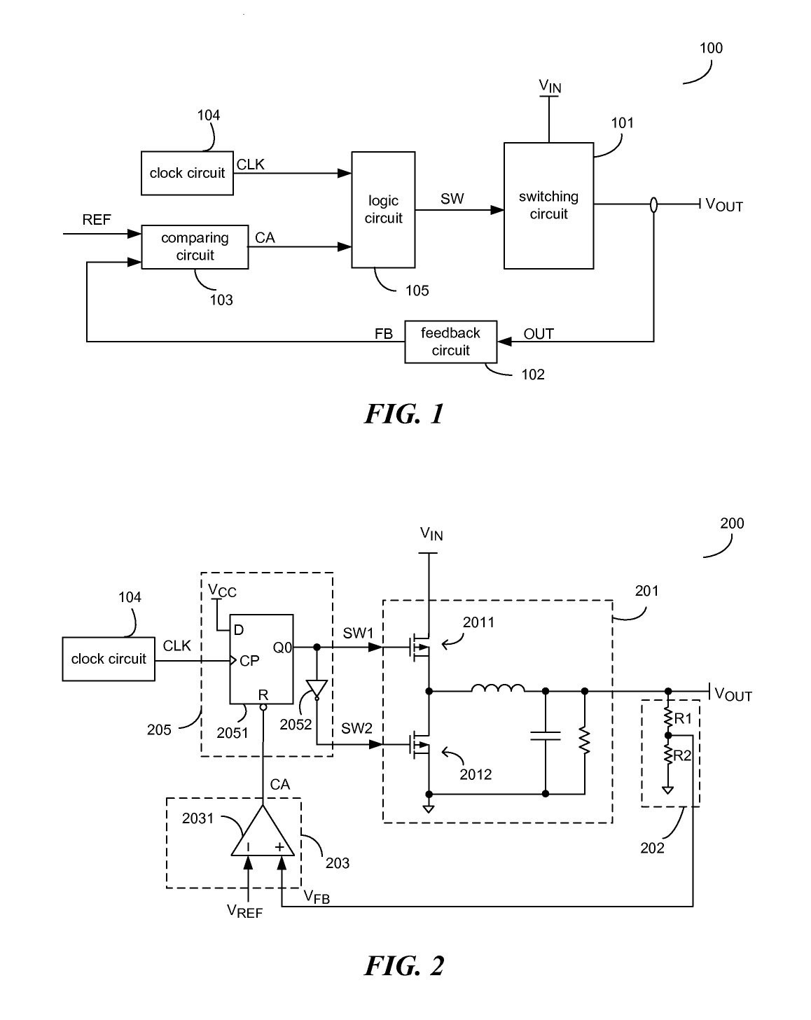

FIG. 1 illustrates a block diagram of a switching converter 100 according to an embodiment of the present invention. As shown in FIG. 1, the switching converter 100 may comprise a switching circuit 101 and a control circuit. The control circuit may comprise a feedback circuit 102, a comparing circuit 103, a clock circuit 104 and a logic circuit 105.

The switching circuit 101 may comprise at least one switch having a first state and a second state. The switching circuit 101 may be configured to convert an input voltage V_{IN} to an output voltage V_{OUT} by controlling the at least one switch to switch between the first state and the second state. In one embodiment, the first state is an on state and the second state is an off state. In another embodiment, the first state is an off state and the second state is an on state. The switching circuit 101 may be configured to have a Buck switching circuit topology, a Boost switching circuit topology, a Buck-Boost switching circuit topology or a Flyback switching circuit topology etc. The at least one switch may comprise any semiconductor switching devices, such as a Metal Oxide Semiconductor Field Effect Transistor (MOSFET), an Insulated Gate Bipolar Transistor (IGBT) and the like.

The feedback circuit 102 may comprise an input terminal and an output terminal. The input terminal of the feedback circuit 102 may be coupled to the switching circuit 101 for receiving an output signal OUT of the switching circuit 101. In one embodiment, the output signal OUT may comprise an output voltage signal. In another embodiment, the output signal OUT may comprise an output current signal. The feedback circuit 102 may be configured to provide a feedback signal FB at the output terminal, wherein the feedback signal FB is indicative of the output signal OUT. In one embodiment, the feedback circuit 102 may comprise a voltage divider. In one embodiment, the feedback circuit 102 may comprise a current sensing circuit, e.g. a sensing resistor. In one embodiment, the feedback circuit 102 may also be an individual module separated from the control circuit.

The comparing circuit 103 has a first input terminal, a second input terminal and an output terminal. The first input terminal of the comparing circuit 103 may be coupled to the feedback circuit 102 for receiving the feedback signal FB. The second input terminal of the comparing circuit 103 may be configured to receive a reference signal REF. The comparing circuit 103 may be configured to compare the feedback signal FB with the reference signal REF, and to provide a comparing signal CA at the output terminal of the comparing circuit 103. The comparing signal CA may be configured to make the at least one switch of the switching circuit 101 to start to operate in the second state when the feedback signal FB is larger than the reference signal REF. The comparing signal CA is a logic signal having a first logic state and a second logic low state, wherein the first logic state and the second logic state are complementary. In one embodiment, the comparing signal CA has the first logic state when the feedback signal FB is smaller than the reference signal REF, and the second logic state once the feedback signal FB is larger than the reference signal REF.

Since during most time of an operation period the feedback signal FB is smaller than the reference signal REF, the comparing signal CA is a single pulse signal, wherein the single pulse signal may refer to a signal with high and low logic levels having a narrow high logic pulse width for a positive pulse signal or having a narrow low logic pulse width for a negative pulse signal. In one embodiment, the comparing signal CA is a negative pulse signal, i.e., the comparing signal CA is logic high when the feedback signal FB is smaller than the reference signal REF and is logic low once the feedback signal FB is larger than the reference signal REF, wherein the narrow pulse width of the negative pulse signal is a pulse width of the logic low. In one embodiment, the comparing signal CA is a positive pulse signal, i.e., the comparing signal CA is logic low when the feedback signal FB is smaller than the reference signal REF and is logic high once the feedback signal FB is larger than the reference signal REF, wherein the narrow pulse width of the negative pulse signal is a pulse width of the logic high.

The clock circuit 104 may be configured to provide a clock signal CLK which is configured to make the at least one switch of the switching circuit 101 to operate in the first state once a rising edge of the clock signal CLK arrives. For example, in one embodiment, if the clock signal CLK is configured to turn the at least one switch of the switching circuit 101 on, then the comparing signal CA is configured to turn it off. In another embodiment, if the clock signal CLK is configured to turn the at least one switch of the switching circuit 101 off, then the comparing signal CA is configured to turn it on. In one embodiment, the clock circuit 104 may comprise an RC oscillator. In another embodiment, the clock circuit 104 may comprise a crystal oscillator.

The logic circuit 105 has a first input terminal, a second input terminal and an output terminal. The first input terminal of the logic circuit 105 may be coupled to the comparing circuit 103 for receiving the comparing signal CA. The second input terminal of the logic circuit 105 may be coupled to the clock circuit 104 for receiving the clock signal CLK. The logic circuit 105 may be configured to conduct a logical operation to the clock signal CLK and the comparing signal CA, and to provide a switching signal SW at the output terminal. The output terminal of the logic circuit 105 may be coupled to the switching circuit 101 for providing the control signal SW to the at least one switch of the switching circuit 101, wherein the control signal SW is a PWM signal. The control signal SW is configured to switch the at least one switch of the switching circuit 101 between the first state and the second state. In one embodiment, the logic circuit 105 may comprise an edge triggered circuit, e.g., D-type flip-flop. In another embodiment, the logic circuit 105 may comprise a latch circuit, e.g., RS type latch.

In such embodiment, the clock circuit 104 is configured to generate the clock signal CLK, wherein the clock signal CLK is configured to make the at least one switch of the switching circuit 101 to operate in the first state once a rising edge of the clock signal CLK arrives. In the meanwhile, the clock circuit 104 is configured to determine a constant frequency of the switching converter 100 directly, which is different from using a ramp signal to determine a constant frequency in a switching converter with a voltage or current controlled method.

In addition, the comparing circuit 103 is configured to compare the feedback signal FB with the reference signal REF, and to provide the comparing signal CA which is a single pulse signal. The comparing signal CA is configured to make the at least one switch of the switching circuit 101 to start to operate in the second state when the feedback signal FB is larger than the reference signal REF. Therefore, a high-performance error amplifier is not necessary to amplify the difference between the feedback signal FB and the reference signal REF in the embodiment of the switching converter 100. Accordingly, loop compensations are ignored and the dynamic response speed of the switching converter 100 may increase.

FIG. 2 schematically illustrates a switching converter 200 according to an embodiment of the present invention. As shown in FIG. 2, the switching converter 200 may comprise a switching circuit 201 and a control circuit. The control circuit may comprise a feedback circuit 202, a comparing circuit 203, a clock circuit 104 and a logic circuit 205.

The switching circuit 201 may have a Buck switching circuit topology comprising a first switch 2011 and a second switch 2012. The first switch 2011 and the second switch 2012 have a source, a drain and a gate respectively. The input voltage V_{IN} is converted to the output voltage V_{OUT} by switching the first switch 2011 and the second switch 2012 respectively between a first state and a second state. In one embodiment, the first state is an on state and the second state is an off state. In another embodiment, the first state is an off state and the second state is an on state. The first switch 2011 and the second switch 2012 may comprise any semiconductor switching devices, such as a MOSFET, an IGBT and the like. Meanwhile, the second switch 2012 may further comprise a diode or a synchronous diode. In FIG. 2, the first switch 2011 and the second switch 2012 are illustrated as MOSFETs, wherein each of the MOSFETs has a gate, a source and a drain.

The feedback circuit 202 may comprise a first resistance R1 and a second resistance R2. The first resistance R1 and the second resistance R2 have a first terminal and a second terminal respectively. The first terminal of the first resistance R1 operated as an input terminal of the feedback circuit 202 is coupled to the switching circuit 201 for receiving an output voltage signal V_{OUT} of the switching circuit 201. The second terminal of the first resistance R1 is coupled to the first terminal of the second resistance R2 to constitute a common node as an output terminal of the feedback circuit 202. The second terminal of the second resistance R2 is connected to a logic ground. The feedback circuit 202 is configured to provide a voltage feedback signal V_{FB} at the common node of the first resistance R1 and the second resistance R2, wherein the voltage feedback signal V_{FB} is indicative of the output voltage signal V_{OUT}.

The comparing circuit 203 may comprise a voltage comparator 2031 having a non-inverting input terminal, an inverting input terminal and an output terminal. In one embodiment, the non-inverting input terminal of the voltage comparator 2031 may be coupled to the output terminal of the feedback circuit 202 to receive the voltage feedback signal V_{FB}. The inverting input terminal of the voltage comparator 2031 may be configured to receive a voltage reference signal V_{REF}. The voltage comparator 2031 may be configured to compare the voltage feedback signal V_{FB} with the voltage reference signal V_{REF} so as to provide the comparing signal CA at the output terminal of the voltage comparator 2031. The comparing signal CA is configured to switch the first switch 2011 and the second switch 2012 between the first state and the second state. The comparing signal CA is logic high when the voltage feedback signal V_{FB} is larger than the voltage reference signal V_{REF}, and is logic low once the voltage feedback signal V_{FB} is smaller than the reference signal V_{REF}. During the most operation period, the feedback signal FB is smaller than the reference signal REF. Therefore, the comparing signal CA is a positive single pulse signal in this circumstance.

In another embodiment, the inverting input terminal of the voltage comparator 2031 may be coupled to the output terminal of the feedback circuit 202 to receive the voltage feedback signal V_{FB}. The non-inverting input terminal of the voltage comparator 2031 may be configured to receive a voltage reference signal V_{REF}. The voltage comparator 2031 may be configured to compare the voltage feedback signal V_{FB} with the voltage reference signal V_{REF} so as to provide the comparing signal CA at the output terminal of the voltage comparator 2031. The comparing signal CA is logic high when the voltage feedback signal V_{FB} is smaller than the voltage reference signal V_{REF}, and is logic low once the voltage feedback signal V_{FB} is larger than the reference signal V_{REF}. During the most operation period, the feedback signal FB is smaller than the reference signal REF. Therefore, the comparing signal CA is a negative single pulse signal in this circumstance.

The logic circuit 205 has a first input terminal, a second input terminal, a first output terminal and a second output terminal. The first input terminal of the logic circuit 205 may be coupled to the output terminal of the comparator 2031 to receive the comparing signal CA. The second input terminal of the logic circuit 205 may be coupled to the clock circuit 104 to receive the clock signal CLK. The first output terminal of the logic circuit 205 may be coupled to the gate of the first switch 2011 so as to provide a first control signal SW1 to switch the first switch 2011. The second output terminal of the logic circuit 205 may be coupled to the gate of the second switch 2012 so as to provide a second control signal SW2 to switch the second switch 2012. The first control signal SW1 has a logic high state and a logic low state, and the second control signal SW2 has a logic high state and a logic low state. The first control signal SW1 and the second control signal SW2 are logic complementary.

The logic circuit 205 may comprise an edge triggered flip-flop. The edge triggered flip-flop is configured to conduct a logical operation to the clock signal CLK and the comparing signal CA once a rising edge of the clock signal CLK arrives. In one embodiment, the logic circuit 205 may comprise a D-type flip-flop 2051. The D-type flip-flop 2051 may have a data input terminal D, a reset terminal R, an edge control terminal CP and an output terminal Q0. In one embodiment, the data input terminal D of the D-type flip-flop 2051 is configured to receive a positive supply voltage VCC. The reset terminal R of the D-type flip-flop 2051 operated as the first input terminal of the logic circuit 205 may be coupled to the output terminal of the comparator 2031 to receive the comparing signal CA. The edge control terminal CP of the D-type flip-flop 2051 operated as the second input terminal of the logic circuit 205 may be coupled to the clock circuit 104 to receive the clock signal CLK. The output terminal Q0 of the D-type flip-flop 2051 operated as the first output terminal of the logic circuit 205 may be coupled to the gate of the first switch 2011 to provide the first control signal SW1.

The logic circuit 205 may further comprise an inverter 2052. As shown in FIG. 2, the inverter 2052 has an input terminal and an output terminal. The input terminal of the inverter 2052 is coupled to the output terminal Q0 of the D-type Flip-flop 2051 to receive the first control signal SW1. The output terminal of the inverter 2052 operated as the second output terminal of the logic circuit 205 is coupled to the gate of the second switch 2012 to provide the second control signal SW2. During one operation cycle, when the rising edge of the clock signal CLK arrives, the data input terminal D of the D-type Flip-flop 2051 may be active so that the first control signal SW1 may be logic high so as to turn the first switch 2011 on. Accordingly, the second control signal SW2 is logic low so as to set the second switch 2012 off. Once the comparing signal CA is logic high, the D-type Flip-flop 2051 may be reset so that the first control signal SW1 may be logic low so as to turn the first switch 2011 off. Correspondingly, the second control signal SW2 is logic high so as to set the second switch 2012 on.

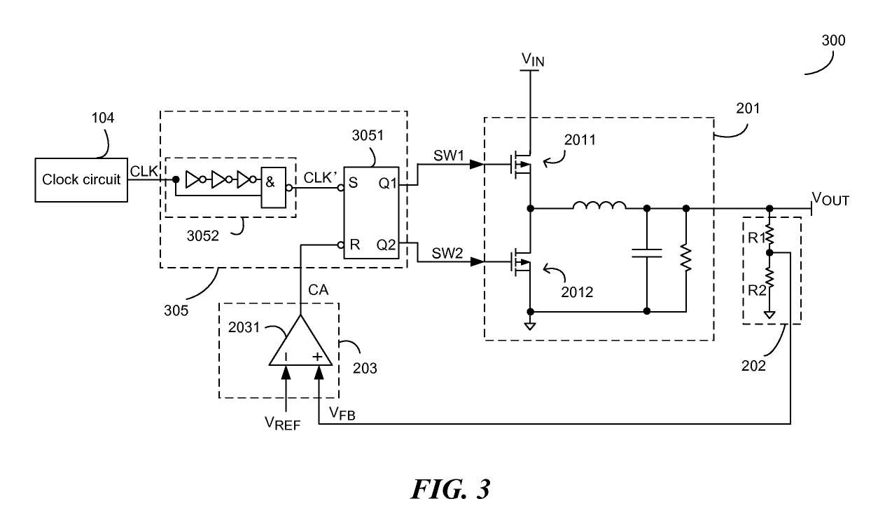

FIG. 3 schematically illustrates a switching converter 300 according to an embodiment of the present invention. Comparing to the switching converter 200, the switching converter 300 may comprise a logic circuit 305 different from the logic circuit 205 of the switching converter 200. As shown in FIG. 3, the logic circuit 305 has a first input terminal, a second input terminal, a first output terminal and a second output terminal. The first input terminal of the logic circuit 305 may be coupled to the output terminal of the comparator 2031 to receive the comparing signal CA. The second input terminal of the logic circuit 305 may be coupled to the clock circuit 104 to receive the clock signal CLK. The first output terminal of the logic circuit 305 may be coupled to the first switch 2011 so as to provide a first control signal SW1 to switch the first switch 2011. The second output terminal of the logic circuit 305 may be coupled to the second switch 2012 so as to provide a second control signal SW2 to switch the second switch 2012.

The logic circuit 305 may comprise a latch. The latch may be configured to conduct a logical operation to the clock signal CLK and the comparing signal CA. In one embodiment, the logic circuit 305 may comprise an RS-type latch 3051. In order to avoid two logic high signals provided to the first input terminal and the second input terminal of the RS-type latch 3051 simultaneously, the logic circuit 305 may further comprise a single pulse generator 3052. The single pulse generator 3052 has an input terminal and an output terminal. The input terminal of the single pulse generator 3052 operated as the second input terminal of the logic circuit 305 is configured to receive the clock signal CLK. The single pulse generator 3052 is configured to generate a single pulse signal CLK′ at the output terminal once the rising edge of the clock signal CLK arrives. In one embodiment, the single pulse generator 3052 may comprise an odd plurality of inverters connected in series with an NAND gate circuit.

The RS-type latch 3051 has a first input terminal R, a second input terminal S, a first output terminal Q1 and a second output terminal Q2. The first input terminal R of the RS-type latch 3051 operated as the first input terminal of the logic circuit 305 is coupled to the output terminal of the comparing circuit 203 to receive the comparing signal CA. The second input terminal S of the RS-type latch 3051 is coupled to the output terminal of the single pulse generator 3052. The first input terminal Q1 of the RS-type latch 3051 operated as the first output terminal of the logic circuit 305 is coupled to the first switch 2011 so as to provide the first control signal SW1 to switch the first switch 2011. The second output terminal Q2 of the RS-type latch 3051 operated as the second output terminal of the logic circuit 305 may be coupled to the second switch 2012 so as to provide the second control signal SW2 to switch the second switch 2012, wherein the first control signal SW1 and the second control signal SW2 are logic complementary. When the single pulse signal CLK′ arrives, the first input terminal Q1 of the RS-type latch 3051 provides the first control signal SW1 with logic high so as to turn the first switch 2011 on, and the second input terminal Q2 of the RS-type latch 3051 provides the second control signal SW2 with logic low so as to turn the second switch 2012 off. Once the comparing signal CA is logic high, the first input terminal Q1 of the RS-type latch 3051 provides the first control signal SW1 with logic low so as to turn the first switch 2011 off, and the second input terminal Q2 of the RS-type latch 3051 provides the second control signal SW2 with logic high so as to turn the second switch 2012 on.

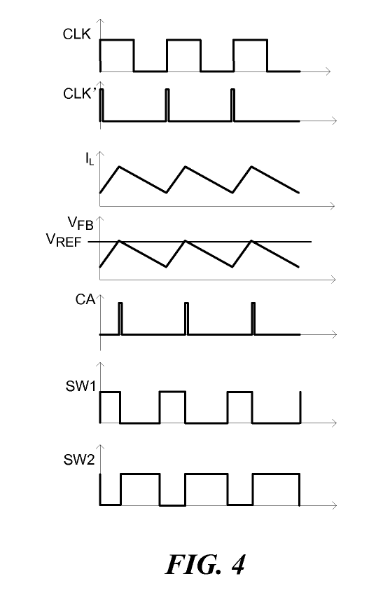

FIG. 4 illustrates a schematic waveform diagram of various signals generated in each switching cycle of the switching converter 300 according to an embodiment of the present invention. As shown in FIG. 4, during one operation cycle, when the rising edge of the clock signal CLK arrives, the single pulse generator 3052 may generate the single pulse signal CLK′. Correspondingly, the first input terminal Q1 of the RS-type latch 3051 may provide the first control signal SW1 with logic high so as to turn the first switch 2011 on, and the second input terminal Q2 of the RS-type latch 3051 may provide the second control signal SW2 with logic low so as to turn the second switch 2012 off. Meanwhile, an inductor current I_{L} of the switching circuit 201 may increase linearly and the voltage feedback signal V_{FB} of the feedback circuit 202 may increase correspondingly. Once the voltage feedback signal V_{FB} is larger than the reference voltage V_{REF} of the feedback circuit 202, the comparing signal CA may change to logic high so as to reset the RS-type latch 3051. Correspondingly, the first input terminal Q1 of the RS-type latch 3051 provides the first control signal SW1 with logic low so as to turn the first switch 2011 off, and the second input terminal Q2 of the RS-type latch 3051 provides the second control signal SW 2 with logic high so as to turn the second switch 2012 on. Meanwhile, the inductor current I_{L} of the switching circuit 201 may arrive at the peak value and begin to decrease linearly, and the voltage feedback signal V_{FB} of the feedback circuit 202 may decrease correspondingly. The first switch 2011 may be turned on and the second switch 2012 may be turned off again until the next single pulse signal CLK′ arrives. The above operation process repeats.

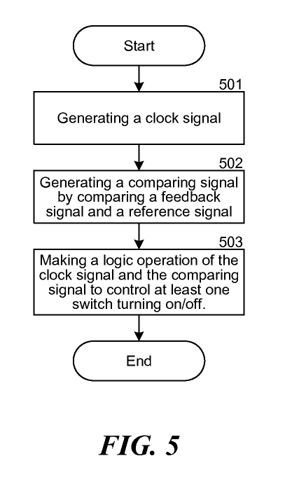

FIG. 5 illustrates a flow diagram illustrating a control method for controlling a switching converter (such as the switching converter 100 or 200 or 300) according to an embodiment of the present invention. The control method may comprise steps 501-512.

In step 501, a clock signal CLK is generated by a clock circuit, such as the clock circuit 104 of the switching converter 100. In one embodiment, the clock signal CLK is configured to control at least one switch of a switching circuit, e.g. the first switch 2011 and/or the second switch 2012 of the switching circuit 201, to operate in a first state. In one embodiment, the clock circuit 104 may comprise a RC oscillator. In another embodiment, the clock circuit 104 may comprise a crystal oscillation generator.

In step 502, a comparing signal CA is generated by a comparing circuit, such as the comparing circuit 103 of the switching converter 100. In one embodiment, the comparing circuit 103 is configured to compare a feedback signal FB with a reference signal REF so as to generate the comparing signal CA. The comparing signal CA is configured to control the at least one switch of the switching circuit, such as the first switch 2011 and/or the second switch 2012 of the switching circuit 201, to operate in a second state. In one embodiment, the comparing signal CA may comprise a positive single pulse signal, i.e., the pulse width of the comparing signal CA is the pulse width of the logic high. In such application, the comparing signal CA is logic high when the feedback signal FB is larger than the reference signal REF. On the contrary, the comparing signal CA is logic low when the feedback signal FB is smaller than the reference signal REF. In another embodiment, the comparing signal CA may comprise a negative single pulse signal, i.e., the pulse width of the comparing signal CA is the pulse width of the logic low. Correspondingly, the comparing signal CA is logic low when the feedback signal FB is larger than the reference signal REF. And the comparing signal CA is logic high when the feedback signal FB is smaller than the reference signal REF.

In one embodiment, the first switch 2011 and/or the second switch 2012 of the switching circuit 201 operating in a first state means the first switch 2011 of the switching circuit 201 is on and the second switch 2012 of the switching circuit 201 is off. The first switch 2011 and/or the second switch 2012 of the switching circuit 201 operating in a second state means the first switch 2011 of the switching circuit 201 is off and the second switch 2012 of the switching circuit 201 is on.

The control method may further comprise a step 503. In step 503, at least one switching signal is generated by a logic circuit, such as the logic circuit 105 of the switching converter 100. In one embodiment, the logic circuit 105 is configured to conduct a logical operation to the clock signal CLK and the comparing signal CA, and to provide the at least one switching signal SW. The at least one switching signal SW may be configured to control the at least one switch of the switching circuit 101 to switch between the first state and the second state. In one embodiment, the at least one switching signal SW may comprise a first control signal SW1 and a second control signal SW2, wherein the first control signal SW1 has a logic high state and a logic low state, and the second control signal SW2 has a logic high state and a logic low state. The first control signal SW1 and the second control signal SW2 are logic complementary. In one embodiment, the first control signal SW1 is configured to control the first switch 2011 of the switching circuit 201 to switch between the first state and the second state. The second control signal SW2 is configured to control the second switch 2012 of the switch circuit 201 to switch between the first state and the second state.

In one embodiment, the logic circuit may comprise an edge triggered flip-flop, such as the D-type flip-flop 2051. In one embodiment, the D-type flip-flop 2051 may have a data input terminal D, a reset terminal R, an edge control terminal CP and an output terminal Q0. The data input terminal D of the D-type flip-flop 2051 may be configured to receive a positive supply voltage VCC. The reset terminal R of the D-type flip-flop 2051 may be configured to receive the comparing signal CA. The edge control terminal CP of the D-type flip-flop 2051 may be configured to receive the clock signal CLK. The output terminal Q0 of the D-type flip-flop 2051 may be coupled to a gate of the first switch 2011 to provide the first control signal SW1.

The logic circuit may further comprise an inverter, such as the inverter 2052. The inverter 2052 has an input terminal and an output terminal. The input terminal of the inverter 2052 is coupled to the output terminal Q0 of the D-type flip-flop 2051 to receive the first control signal SW1. The output terminal of the inverter 2052 is configured to couple to the second switch 2012 to provide the second control signal SW2. During one operation cycle, when the rising edge of the clock signal CLK arrives, the data input terminal D of the D-type flip-flop 2051 may be active so that the first control signal SW1 may be logic high so as to set the first switch 2011 on. Accordingly, the second control signal SW2 is logic low so as to set the second switch 2012 off. Once the comparing signal CA is logic high, the D-type flip-flop 2051 may be reset so that the first control signal SW1 may be logic low so as to turn the first switch 2011 off. Correspondingly, the second control signal SW2 may be logic high so as to set the second switch 2012 on.

In another embodiment, the logic circuit may comprise a latch, such as the RS-type latch 3051. In one embodiment, the RS-type latch 3051 has a first input terminal R, a second input terminal S, a first output terminal Q1 and a second output terminal Q2. The first input terminal R of the RS-type latch 3051 may be configured to receive the comparing signal CA. The second input terminal S of the RS-type latch 3051 is configured to receive a single pulse signal, such as the single pulse signal CLK′. The first input terminal Q1 of the RS-type latch 3051 is coupled to the first switch 2011 so as to provide the first control signal SW1 to switch the first switch 2011. The second output terminal Q2 of the RS-type latch 3051 may be configured to operate as the second output terminal of the logic circuit 305, and be coupled to the second switch 2012 so as to provide the second control signal SW2 to switch the second switch 2012. In one embodiment, when the single pulse signal CLK′ arrives, the first input terminal Q1 of the RS-type latch 3051 provides the first control signal SW1 with logic high so as to turn the first switch 2011 on, and the second input terminal Q2 of the RS-type latch 3051 provides the second control signal SW2 with logic low so as to turn the second switch 2012 off. Once the comparing signal CA is logic high, the first input terminal Q1 of the RS-type latch 3051 may provide the first control signal SW1 with logic low so as to turn the first switch 2011 off, and the second input terminal Q2 of the RS-type latch 3051 may provide the second control signal SW 2 with logic high so as to turn the second switch 2012 on.

The logic circuit may further comprise a single pulse generator 3052. The single pulse generator 3052 having an input terminal and an output terminal. The input terminal of the single pulse generator 3052 may be coupled to the clock circuit 104, and configured to receive the clock signal CLK. The output terminal of the single pulse generator 3052 may be coupled to the second input terminal S of the RS-type latch 3051, and be configured to provide the single pulse signal CLK′ once the rising edge of the clock signal CLK arrives.

In the description of the control method of the present invention, the step 502 follows the step 501. However, it should be known for an ordinary skill in the art that, the step 501 and the step 502 may happen simultaneously.

It should be noted that the ordinary skill in the art should know that the switching converter and the control method presented in this invention not only limited in a topology, but also in other large applications needed. Similarly, the sensing circuit, controller etc. presented in this invention only used to schematically show a method as an example.

While various embodiments have been described above, it should be understood that they have been presented by way of example only, and not limitation. Thus, the breadth and scope of a prefV1ed embodiment should not be limited by any of the above-described exemplary embodiments, but should be defined only in accordance with the following claims and their equivalents.

I/We claim:

1. A control circuit for a switching converter, wherein the switching converter comprises at least one switch, and wherein the switching converter is configured to receive an input voltage signal and to convert the input voltage signal to an output voltage signal by switching the at least one switch between a first state and a second state, the control circuit comprising:
a clock circuit configured to generate a clock signal, wherein the clock signal is configured to make the at least one switch to operate in a first state once a rising edge of the clock signal arrives; and
a comparing circuit having a first input terminal, a second input terminal and an output terminal, wherein the first input terminal of the comparing circuit is configured to receive a feedback signal indicative of an output signal of the switching converter, and wherein the second input terminal of the comparing circuit is configured to receive a reference signal, and wherein the comparing circuit is configured to compare the feedback signal with the reference signal to generate a comparing signal at the output terminal, and wherein the comparing signal is configured to make the at least one switch to start to operate in a second state when the feedback signal is larger than the reference signal.

2. The control circuit of claim 1, further comprising a logic circuit having a first input terminal, a second input terminal and at least one output terminal, wherein
the first input terminal of the logic circuit is coupled to the output terminal of the comparing circuit for receiving the comparing signal; the second input terminal of the logic circuit is coupled to the clock signal for receiving the clock signal; the logic circuit is configured to conduct a logical operation to the comparing signal and the clock signal, and is configured to generate at least one control signal at the at least one output terminal respectively; and
the at least one control signal is configured to switch the at least one switch between the first state and the second state.

3. The control circuit of claim 2, wherein the at least one switch comprises a first switch and a second switch;
the at least one control signal comprises a first control signal and a second control signal, wherein the first control signal and the second control signal are logic complementary;
the at least one output terminal comprises a first output terminal configured to provide the first control signal, and a second output terminal configured to provide the second control signal; and wherein
the first control signal is configured to switch the first switch on and off, and the second control signal is configured to switch the second switch on and off.

4. The control circuit of claim 3, wherein the first state comprises an on state of the first switch and an off state of the second switching; and wherein the second state comprises an off state of the first switch and an on state of the second switch.

5. The control circuit of claim 3, wherein the logic circuit comprising:
a single pulse generator having an input terminal and an output terminal, wherein the input terminal of the single pulse generator is configured to operate as the second input terminal of the logic circuit, and to receive the clock signal, and wherein the single pulse generator is configured to generate a single pulse signal at the output terminal once the rising edge of the clock signal arrives; and
a latch having a first input terminal, a second input terminal, a first output terminal and a second output terminal, wherein the first input terminal of the latch is configured to operate as the first input terminal of the logic circuit, and is coupled to the output terminal of the comparing circuit for receiving the comparing signal; the second input terminal of latch is coupled to the output terminal of the single pulse generator for receiving the single pulse signal; the first input terminal of the latch is configured to operate as the first output terminal of the logic circuit, and is coupled to the first switch so as to provide the first control signal, wherein the first control signal is configured to switch the first switch on and off; and the second input terminal of the latch is configured to operate as the second output terminal of the logic circuit, and is coupled to the second switch so as to provide the second control signal, wherein the second control signal is configured to switch the second switch on and off.

6. The control circuit of claim 5, wherein the latch comprises an RS-type latch.

7. The control circuit of claim 3, wherein the logic circuit comprises:
an edge triggered flip-flop having a data input terminal, a reset terminal, an edge control terminal and an output terminal, wherein the data input terminal of the edge triggered flip-flop is configured to receive a positive supply voltage; the reset terminal of the edge triggered flip-flop is configured to operate as the first input terminal of the logic circuit, and is coupled to the output terminal of the comparing circuit for receiving the comparing signal; the edge control terminal of the edge triggered flip-flop is configured to operate as the second input terminal of the logic circuit, and is coupled to the clock circuit for receiving the clock signal; and the output terminal of the edge triggered flip-flop is configured to operate as the first output terminal of the logic circuit, and is coupled to the first switch so as to provide the first control signal, wherein the first control signal is configured to turn the first switch on and off; and
an inverter having an input terminal and an output terminal, wherein the input terminal of the inverter is coupled to the output terminal of the edge triggered flip-flop for receiving the first control signal; and the output terminal of the inverter is configured to operate as the second output terminal of the logic circuit, and is coupled to the second switch so as to provide the second control signal, wherein the second control signal is configured to turn the second switch on and off.

8. The control circuit of claim 7, wherein the edge triggered flip-flop comprises a D-type edge triggered flip-flop.

9. The control circuit of claim 1, wherein the comparing signal has a first logic state and a second logic state, and wherein the first logic state and the second logic state are complementary, and wherein the comparing signal is in the first logic state when the feedback signal is larger than the reference signal, and the comparing signal is in the second logic state when the feedback signal is smaller than the reference signal.

10. The control circuit of claim 1, wherein the comparing circuit comprises a voltage comparator having a first input terminal, a second input terminal and an output terminal; and wherein
the first input terminal of the voltage comparator is configured to receive a voltage feedback signal, wherein the voltage feedback signal is indicative of an output voltage signal of the switching converter; the second input terminal of the voltage comparator is configured to receive a voltage reference signal; and the voltage comparator is configured to compare the voltage feedback signal with the voltage reference signal, and to provide a voltage comparing signal at the output terminal.

11. A switching converter, comprising:
at least one switch, and wherein the switching converter is configured to receive an input voltage signal and to convert the input voltage signal to an output voltage signal by switching the at least one switch between a first state and a second state;
a clock circuit configured to generate a clock signal, wherein the clock signal is configured to make the at least one switch to operate in a first state once a rising edge of the clock signal arrives; and
a comparing circuit having a first input terminal, a second input terminal and an output terminal, wherein the first input terminal of the comparing circuit is configured to receive a feedback signal indicative of an output signal of the switching converter, and wherein the second input terminal of the comparing circuit is configured to receive a reference signal, and wherein the comparing circuit is configured to compare the feedback signal with the reference signal to generate a comparing signal at the output terminal, and wherein the comparing signal is configured to make the at least one switch to start to operate in a second state when the feedback signal is larger than the reference signal.

12. A control method for controlling a switching converter, wherein the switching converter comprises at least one switch; and wherein the switching converter is configured to receive an input voltage signal; and wherein the switching converter is configured to convert the input voltage signal to an output voltage signal by switching the at least one switch; the control method comprising:
generating a clock signal, wherein the clock signal is configured to make the at least one switch to operate in a first state;
comparing a feedback signal with a reference signal to generate a comparing signal, wherein the comparing signal is configured to make the at least one switch to start to operate in a second state when the feedback signal is larger than the reference signal.

13. The control method of claim 12, wherein the comparing signal has a first logic state and a second logic state, and wherein the first logic state and the second logic state are complementary, and wherein the comparing signal is in the first logic state when the feedback signal is larger than the reference signal, and the comparing signal is in the second logic state when the feedback signal is smaller than the reference signal.

14. The control method of claim 12, further comprising:
conducting a logical operation to the comparing signal and the clock signal so as to generate at least one control signal, wherein the at least one control signal is configured to switch the at least one switch between the first state and the second state.

15. The control method of claim 14, wherein conducting a logical operation to the comparing signal and the clock signal to generate at least one control signal further comprising:
generating a single pulse signal at the rising edge of the clock signal, wherein the single pulse signal is configured to make the at least one switch to operate in the first state.

16. The control method of claim 14, wherein the at least one switch comprises a first switch and a second switch;
the at least one control signal comprises a first control signal and a second control signal, wherein the first control signal and the second control signal are logic complementary; and
the first control signal is configured to switch the first switch on and off, and the second control signal is configured to switch the second switch on and off.

17. The control method of claim 12, wherein the first state comprises an on state of the first switch and an off state of the second switch; and the second state comprises an off state of the first switch and an on state of the second switch.

18. The control method of claim 12, wherein comparing a feedback signal with a reference signal to generate a comparing signal further comprising:
comparing a voltage feedback signal with a voltage reference signal so as to generate a voltage comparing signal by a voltage comparator.
